(19) United States
(12) Patent Application Publication
(10) Pub. No.: US 2022/0016555 A1
(43) Pub. Date: Jan. 20, 2022

(54) MESH FILTER

(71) Applicant: Enplas Corporation, Kawaguchi-shi, Saitama (JP)

(72) Inventors: Koji Noguchi, Saitama (JP); Shigeru Uemura, Saitama (JP)

(21) Appl. No.: 17/299,327

(22) PCT Filed: Nov. 28, 2019
(86) PCT No.: PCT/JP2019/046530

§ 371 Date: Jun. 3, 2021

(30) Foreign Application Priority Data
Dec. 3, 2018 (JP) 2018-226275

(51) Int. Cl. B01D 39/16; B01D 46/10; B01D 29/01; B29C 45/00; B29C 45/26

(52) U.S. Cl. CPC B01D 39/1692; B01D 46/10; B01D 29/01; B29L 2031/14; B29C 45/263; B01D 2275/202; B29C 45/0046

(57) ABSTRACT

Provided is an inexpensive mesh filter with high productivity. This mesh filter, which is an integrally molded product of resin, includes: a mesh part in which a plurality of ribs are disposed in a lattice shape; a rim part which is formed in an annular shape so as to surround the mesh part, and to which the plurality of ribs are connected; and a final filling part which is disposed on the inner side of the rim part, and to which some of the plurality of ribs are connected. The cross-sectional area of at least one rib among the ribs connected to the final filling part is smaller than the cross-sectional area of at least one rib among the ribs not connected to the final filling part.

### TECHNICAL FIELD

The present invention relates to a mesh filter that is an integrally molded resin product.

### BACKGROUND ART

Filters have been used to remove foreign substances from fluids such as liquids and gases (see, for example, Patent Literature (hereinafter, referred to as “PTL”) 1). In accordance with the size of foreign substances to be removed, a filter having holes with a size such that the foreign substances can be removed is selected. The filter can capture only foreign substances by allowing a fluid that contains the foreign substances to pass therethrough.

PTL 1 describes a mesh filter integrally molded by injection molding of a resin. The mesh filter described in PTL 1 includes a mesh formed in a grid pattern and a crosspiece disposed so as to surround the mesh.

The mesh filter described in PTL 1 is manufactured by pouring a molten resin into the cavity from a gate disposed at a position corresponding to the crosspiece.

### CITATION LIST

### Patent Literature

PTL 1
Japanese Patent Application Laid-Open No. 2002-067107

### SUMMARY OF INVENTION

### Technical Problem

For efficiently removing fine foreign substances, a filter with a large number of small holes is required. It is necessary to dispose thin ribs at narrow intervals to form a large number of small holes for manufacturing such a filter. During the filling process of a cavity with a molten resin, the cavity may be incompletely filled with the molten resin because of the thinness of the cavity.

Non-woven fabrics may also be used to efficiently remove fine foreign substances. However, non-woven fabrics are expensive. In addition, non-woven fabrics and the like are, for example, welded to fixing members, and thus the quality of products containing non-woven fabrics tends to vary.

An object of present invention is to provide a mesh filter at low cost with high productivity.

### Solution to Problem

A mesh filter according to the present invention is an integrally molded resin product and includes: a mesh portion in which a plurality of ribs are disposed in a grid pattern; a rim portion formed in an annular shape so as to surround the mesh portion, the rim portion being a portion to which the plurality of ribs are connected; and a final filling portion disposed inside the rim portion, the final filling portion being a portion to which a part of ribs among the plurality of ribs are connected, in which a cross-sectional area of at least one rib of the part connected to the final filling portion is smaller than a cross-sectional area of at least one rib of another part, which is not connected to the final filling portion, in the plurality of ribs.

A cartridge with at least one filter according to the present invention includes a first mesh that is the above-described mesh filter, and a cylinder formed in a cylindrical shape so as to surround the first mesh. The rim portion forms a part of the cylinder, and the first mesh and the cylinder constitute an integrally molded body. The mesh opening of the first mesh filter is 10 to 500 μm. The openings of the first mesh are open in the direction along the central axis of the cylinder. The cartridge with at least one filter according to the present invention further includes a second mesh, which is an integrally molded body made of a resin and in which a plurality of ribs are disposed in a grid pattern, and the first mesh is disposed on the one end side of the cylinder and the second mesh is disposed on the other end side of the cylinder. The cylinder is made of a resin and the first mesh and the cylinder constitute an integrally molded body.

### Advantageous Effects of Invention

The present invention can provide a mesh filter at low cost with high productivity.

### BRIEF DESCRIPTION OF DRAWINGS

FIGS. 1A and 1B illustrate the configuration of a mesh filter according to embodiment 1 of the present invention;

FIGS. 2A to 2D illustrate the configuration of the mesh filter according to embodiment 1 of the present invention;

FIGS. 3A and 3B are schematic views for explaining the flow of a molten resin in a filling step of an injection molding method;

FIGS. 4A and 4B illustrate the configuration of a mesh filter according to embodiment 2 of the present invention;

FIGS. 5A and 5B illustrate the configuration of the mesh filter according to embodiment 2 of the present invention;

FIGS. 6A to 6C illustrate the configuration of a cartridge with at least one filter according to embodiment 3 of the present invention; and

FIGS. 7A to 7C illustrate the configuration of a cartridge with at least one filter according to embodiment 4 of the present invention.

### DESCRIPTION OF EMBODIMENTS

Hereinafter, one or more embodiments of the present invention will be described in detail with reference to the drawings.

### Embodiment 1

Configuration of Mesh Filter

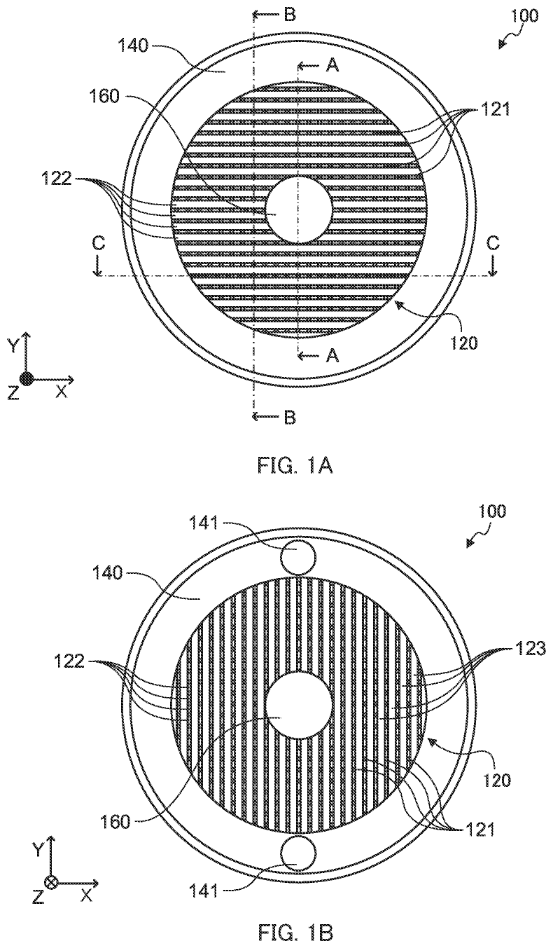

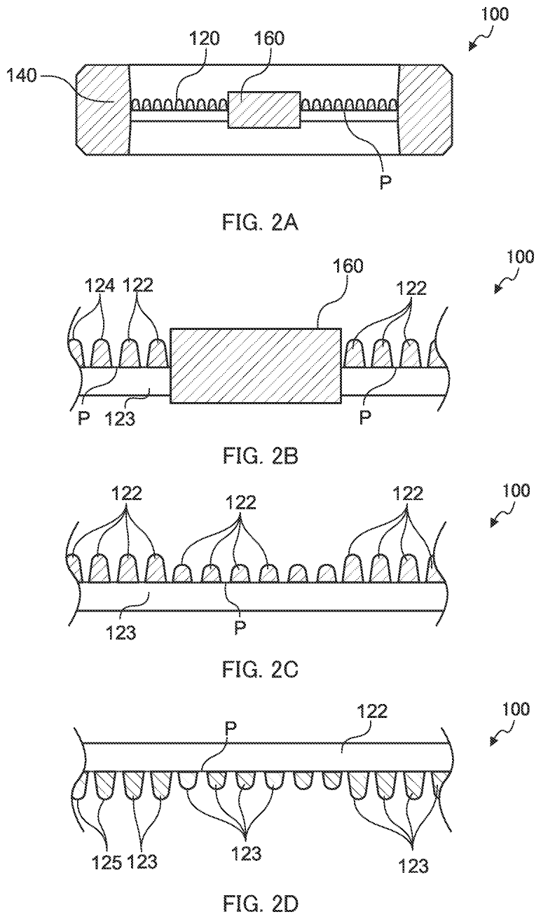

FIGS. 1A, 1B and 2A to 2D illustrate the configuration of mesh filter 100 according to embodiment 1 of the present invention. FIG. 1A is a plan view of mesh filter 100, and FIG. 1B is a bottom view of mesh filter 100. FIG. 2A is a cross-sectional view of mesh filter 100 including the cross section taken along line A-A of FIG. 1A, FIG. 2B is a partially enlarged cross-sectional view taken along line A-A of FIG. 1A, FIG. 2C is a partially enlarged cross-sectional view taken along line B-B of FIG. 1A and FIG. 2D is a partially enlarged cross-sectional view taken along line C-C of FIG. 1A. In the following description, a direction in which first rib 122 extends is defined as the first direction (X direction), a direction which is orthogonal to the first direction (X direction), and in which second rib 123 extends, is defined as the second direction (Y direction), and the height (thickness) direction of first rib 122 and second rib 123, which is orthogonal to the first direction (X direction) and the second direction (Y direction), is defined as the third direction (Z direction).

As illustrated in FIGS. 1A, 1B and 2A to 2D, mesh filter 100 includes mesh portion 120, rim portion 140, and final filling portion 160.

The material of mesh filter 100 is a resin such as polypropylene (PP), polyacetal (POM), or polyamide (PA). Mesh filter 100 is integrally molded by injection molding.

Mesh portion 120 captures foreign substances contained in a fluid such as a gas or a liquid by allowing the fluid to pass therethrough. Mesh portion 120 may have any shape in plan view. In the present embodiment, mesh portion 120 has a circular shape in plan view. A plurality of holes 121 are formed in mesh portion 120. Plurality of holes 121 in mesh portion 120 may have any shape in plan view. The shape of hole 121 in plan view may be a circle or a polygon. In the present embodiment, mesh portion 120 includes plurality of first ribs 122 and a plurality of second ribs 123. Plurality of first ribs 122 and plurality of second ribs 123 form a plurality of holes 121 having a square shape in plan view. The sides of hole 121 may have any length. The length of one side of hole 121 is, for example, 10 to 500 μm. The number of holes 121 may be any number. For example, the number of holes 121 is 1 to 400 per mm².

First rib 122 is a protrusion whose first ridge line 124 extends in the first direction (X direction). Plurality of first ribs 122 are disposed parallel to each other and at equal intervals in the second direction (Y direction) orthogonal to the first direction (X direction). In the present embodiment, plurality of first ribs 122 are disposed on the first surface (front surface) of virtual plane P. The cross section (YZ cross section), orthogonal to the extending direction (X direction), of first rib 122 may have any shape. In the present embodiment, the cross section is substantially in a shape of a triangle where one top including first ridge line 124 has a shape of an arc (see FIGS. 2B and 2C).

As described below, final filling portion 160 is disposed in the central part of mesh portion 120 (see FIG. 1A). That is, regarding first rib 122 passing through the central part of mesh portion 120, one end of first rib 122 is connected to the inner side surface of rim portion 140 and the other end is connected to the side surface of final filling portion 160. Regarding first rib 122 not passing through the central portion of mesh portion 120, both ends of first rib 122 are connected to the inner side surface of rim portion 140.

Second rib 123 is a protrusion whose second ridge line 125 extends in the second direction (Y direction). Plurality of second ribs 123 are disposed parallel to each other and at equal intervals in the first direction (X direction). In the present embodiment, plurality of second ribs 123 are disposed on the second surface (back surface) of virtual plane P. The cross section (XZ cross section), orthogonal to the extending direction (Y direction), of second rib 123 may have any shape. In the present embodiment, the cross section is substantially in a shape of a triangle where one top including second ridge line 125 has a shape of an arc (see FIG. 2D).

As with first ribs 122, regarding second rib 123 passing through the central part of mesh portion 120, one end of second rib 123 is connected to the inner side surface of rim portion 140 and the other end is connected to the side surface of final filling portion 160. Regarding second rib 123 not passing through the central part of mesh portion 120, both ends of second rib 123 are connected to the inner side surface of rim portion 140.

Plurality of first ribs 122 and plurality of second ribs 123 are disposed in a front-to-back relationship with virtual plane P as a boundary. That is, plurality of first ribs 122 and plurality of second ribs 123 are disposed in such a way that the positions of plurality of first ribs 122 differ from the positions of plurality of second ribs 123 in the height direction (Z direction) of the ribs. When mesh portion 120 is viewed in plan view from the top, plurality of second ribs 123 are disposed behind first ribs 122 and at equal intervals in the first direction. Further, when mesh portion 120 is viewed in plan view from the bottom, plurality of first ribs 122 are disposed behind second ribs 123 and at equal intervals in the second direction.

Rim portion 140 holds mesh portion 120. Rim portion 140 is disposed so as to surround mesh portion 120. Rim portion 140 may have any shape in plan view. In the present embodiment, rim portion 140 has an annular shape in plan view. Plurality of first ribs 122 and plurality of second ribs 123 are connected to the inner side surface of rim portion 140. Mark 141 of a gate used at the time of injection molding (hereinafter referred to as “gate mark”) is formed on the rim portion 140. In the present embodiment, two gate marks 141 are formed on the back surface of rim portion 140 so as to be evenly spaced in the circumferential direction of the surface. Gate marks 141 may be formed on the front surface of rim portion 140. In addition, rim portion 140 is formed thicker than mesh portion 120 in the third direction (Z direction) in the present embodiment. This configuration can prevent an operator from touching mesh portion 120 during the handling.

Final filling portion 160 is disposed at mesh portion 120 inside rim portion 140. In the present embodiment, final filling portion 160 is disposed at the central part of mesh portion 120. Mesh portion 120 surrounds final filling portion 160. Final filling portion 160 is a last part to be filled with a molten resin during injection molding, functions as a degassing portion during filling of a cavity with the molten resin, and may function as a part where an ejector pin comes into contact during releasing of an injection molded body. The ejector pin may come into contact from the front surface side of final filling portion 160, or from the back surface side of final filling portion 160. Final filling portion 160 may have any shape as long as the above functions are exhibited. In the present embodiment, final filling portion 160 has a shape of a column. One or more first ribs 122 among plurality of first ribs 122 and one or more second ribs 123 among plurality of second ribs 123 are connected to the side surface of final filling portion 160.

In mesh filter 100 according to the present embodiment, the cross-sectional area of at least one of the ribs connected to final filling portion 160 is smaller than the cross-sectional area of at least one of the ribs not connected to final filling portion 160. Herein, the “cross-sectional area of a rib” means the area of the cross section of the rib in the direction perpendicular to the extending direction of the rib. In the example illustrated in FIGS. 1A, 1B and 2A to 2D, all the cross-sectional areas of first ribs 122 and second ribs 123 connected to final filling portion 160 are the same. All the cross-sectional areas of first ribs 122 and second ribs 123 not connected to final filling portion 160 are the same. As illustrated in FIGS. 2C and 2D, the cross-sectional areas of first ribs 122 and second ribs 123 connected to final filling portion 160 are smaller than the cross-sectional areas of first ribs 122 and second ribs 123 not connected to final filling portion 160. (Herein “a first rib and a second rib connected to a final filling portion” means “a first rib connected to a final filling portion and a second rib connected to the final filling portion,” and “a first rib and a second rib not connected to a final filling portion” means “a first rib not connected to a final filling portion and a second rib not connected to the final filling portion.”)

Method for Manufacturing Mesh Filter

A method for manufacturing mesh filter 100 by using an injection molding method will now be described. The manufacturing of mesh filter 100 by using an injection molding method typically includes a mold clamping step of clamping a mold so that a cavity is formed inside thereof, a filling step of filling the inside of the mold (inside of the cavity) with a molten resin, a pressure holding step of holding the pressure of the resin filling the cavity, and a mold opening step of opening the mold.

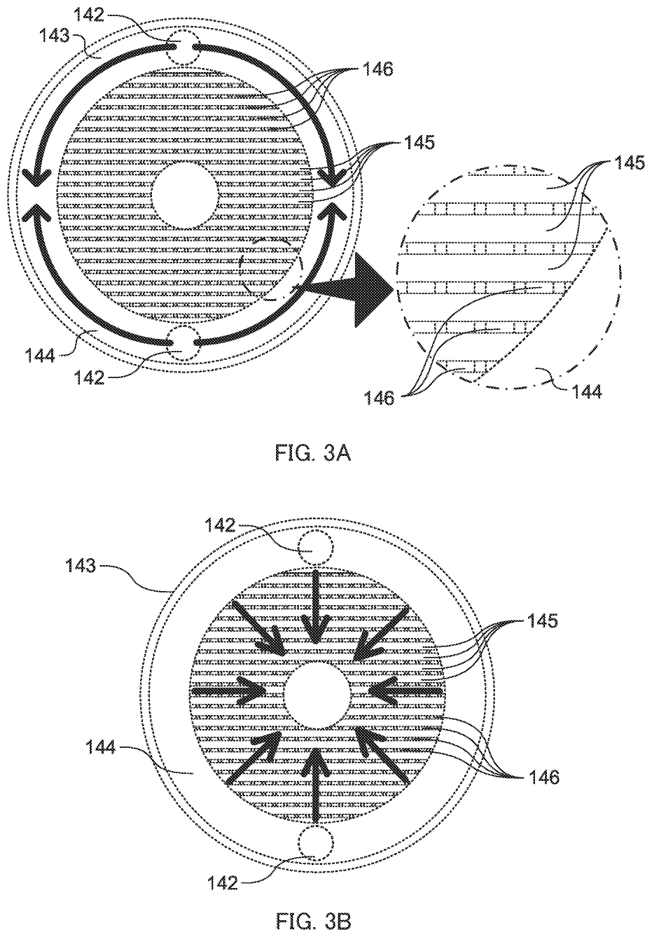

Here, how a molten resin flows in the filling step will be described. FIGS. 3A and 3B are schematic views for explaining the flow of a molten resin in the filling step of the injection molding method. FIG. 3A illustrates the flow of the molten resin in the initial stage of the filling step, and FIG. 3B illustrates the flow of the molten resin in the latter stage of the filling step. The thick arrows in FIGS. 3A and 3B indicate directions in which the molten resin flows.

As illustrated in FIG. 3A, the molten resin fills cavity 143 from gate portion 142 in the filling step. The molten resin firstly fills space 144 corresponding to rim portion 140. This is because space 144 corresponding to rim portion 140 has a larger cross-sectional area than space 145 corresponding to first rib 122 and space 146 corresponding to second rib 123.

When space 144 corresponding to rim portion 140 is filled with the molten resin, space 145 corresponding to first rib 122 and space 146 corresponding to second rib 123 are then filled with the molten resin. As the space corresponding to final filling part 160 functions as a degassing portion, when all the cross-sectional areas of first ribs 122 and second ribs 123 are the same, spaces 145 and 146 corresponding to first rib 122 and second rib 123 connected to final filling portion 160 are more easily filled with the molten resin than spaces 145 and 146 corresponding to first rib 122 and second rib 123 not connected to final filling portion 160. As a result, when the spaces corresponding to final filling portion 160 is filled with the molten resin before spaces 145 and 146 corresponding to first rib 122 and second rib 123 not connected to final filling portion 160 are completely filled with the molten resin, parts of spaces 145 and 146 corresponding to first rib 122 and second rib 123 not connected to final filling portion 160 may not be filled with the molten resin.

As described above, however, the cross-sectional areas of first rib 122 and second rib 123 connected to final filling portion 160 are smaller than the cross-sectional areas of first rib 122 and second rib 123 not connected to final filling portion 160 in mesh filter 100 according to the present embodiment. That is, the cross-sectional area of space 145 corresponding to first rib 122 connected to final filling portion 160 is smaller than the cross-sectional area of space 145 corresponding to first rib 122 not connected to final filling portion 160. The cross-sectional area of space 146 corresponding to second rib 123 connected to final filling portion 160 is smaller than the cross-sectional area of space 146 corresponding to second rib 123 not connected to final filling portion 160 in a similar fashion. As illustrated in FIG. 3B, adjustment is made in such a way that the molten resin fills spaces 145 corresponding to first ribs 122 connected to final filling portion 160, spaces 145 corresponding to first ribs 122 not connected to final filling portion 160, spaces 146 corresponding to second ribs 123 connected to final filling portion 160, and spaces 146 corresponding to second ribs 123 not connected to final filling portion 160 at substantially the same timing. Since the entire cavity is appropriately filled with the molten resin, mesh filters 100 can be manufactured with a high yield.

Effects

In mesh filter 100 according to the present embodiment as described above, the cross-sectional areas of ribs connected to final filling portion 160 are smaller than the cross-sectional areas of ribs not connected to final filling portion 160, and thus, a molten resin evenly fills all ribs from rim portion 140 toward final filling portion 160 at the time of injection molding. Accordingly, mesh filters 100 can be manufactured at low cost with a high yield.

### Embodiment 2

Mesh filter 200 according to embodiment 2 differs from mesh filter 100 according to embodiment 1 only in the configuration of mesh portion 220. The same reference numerals are given to the configurations same as those of mesh filter 100 according to Embodiment 1, and the descriptions thereof will be omitted.

Configuration of Mesh Filter

Mesh filter 200 according to the present embodiment includes mesh portion 220, rim portion 140, and final filling portion 160. Mesh portion 220 includes plurality of first ribs 222 and plurality of second ribs 223.

In the present embodiment, plurality of first ribs 222 and plurality of second ribs 223 are disposed at the same position in the height direction (Z direction) of the ribs. That is, plurality of first ribs 222 and plurality of second ribs 223 are disposed such that first ribs 222 intersect with second ribs 223 in mesh filter 200 according to the present embodiment.

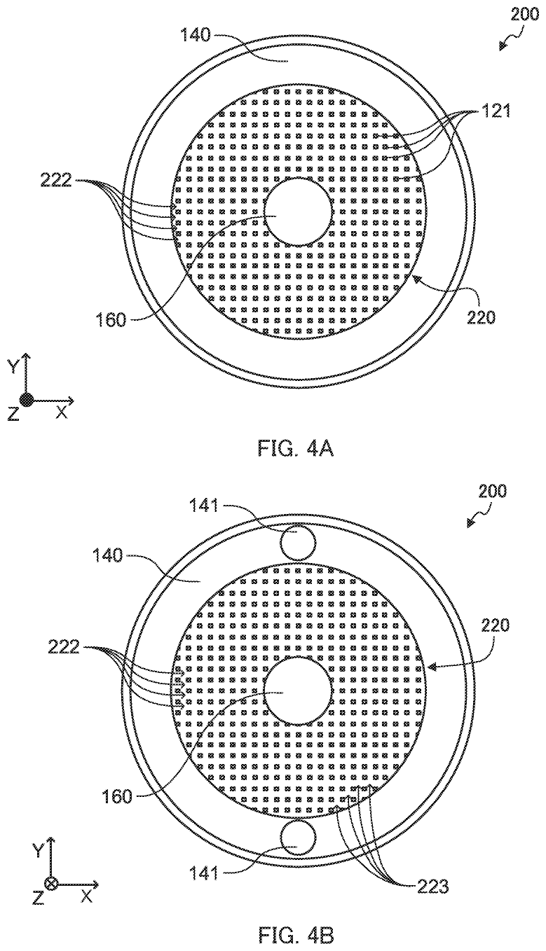

The cross-sectional area of at least one of the ribs connected to final filling portion 160 is smaller than the cross-sectional area of at least one of the ribs not connected to final filling portion 160 also in mesh filter 200 according to the present embodiment. In the example illustrated in FIGS. 4A and 4B, all the cross-sectional areas of first ribs 222 and second ribs 223 connected to final filling portion 160 are the same. All the cross-sectional areas of first ribs 222 and second ribs 223 not connected to final filling portion 160 are also the same. The cross-sectional areas of first ribs 222 and second ribs 223 connected to final filling portion 160 are smaller than the cross-sectional areas of first ribs 222 and second ribs 223 not connected to final filling portion 160.

Effects

Mesh filter 200 according to the present embodiment provides substantially the same effects as that of mesh filter 100 according to Embodiment 1.

All the cross-sectional areas of first ribs 122, 222 (second ribs 123, 223) connected to final filling portion 160 are the same, and all the cross-sectional areas of first ribs 122, 222 (second ribs 123, 223) not connected to final filling portion 160 are the same in the above embodiments. However, the cross-sectional areas of first ribs 122, 222 (second ribs 123, 223) connected to final filling portion 160 may be different from each other, and the cross-sectional areas of first ribs 122, 222 (second ribs 123, 223) not connected to final filling portion 160 may also be different from each other.

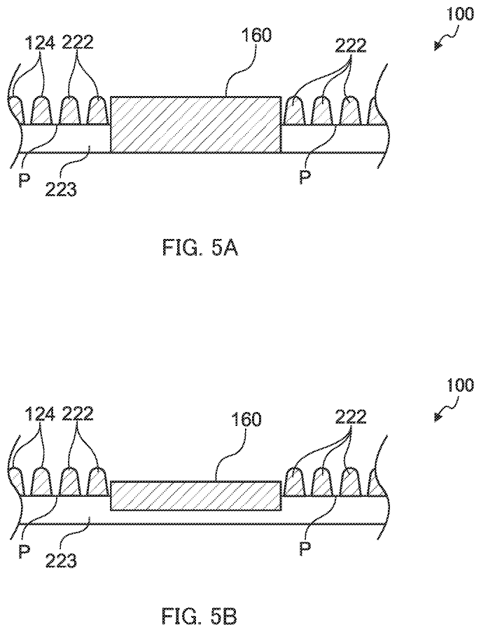

As illustrated in FIG. 5A, final filling portion 160 may be formed to have the same thickness as mesh portion 120 in the third direction (Z direction). Alternatively, as illustrated in FIG. 5B, final filling portion 160 may be formed to be thinner than mesh portion 120 in the third direction (Z direction).

A membrane filter is typically known as a filter with a large number of extremely small holes, but a membrane filter is thin, and thus the membrane filter may not properly adhere to a case when the membrane filter is held in the case. As a result, the quality of products containing membrane filters tends to vary. In addition, products including membrane filters are expensive because of the complicated manufacturing process.

As described below, a cartridge with at least one filter can also be provided at low cost with high productivity by using the filter of the present invention.

### Embodiment 3

Cartridge 300 with at least one filter in embodiment 3 will be described.

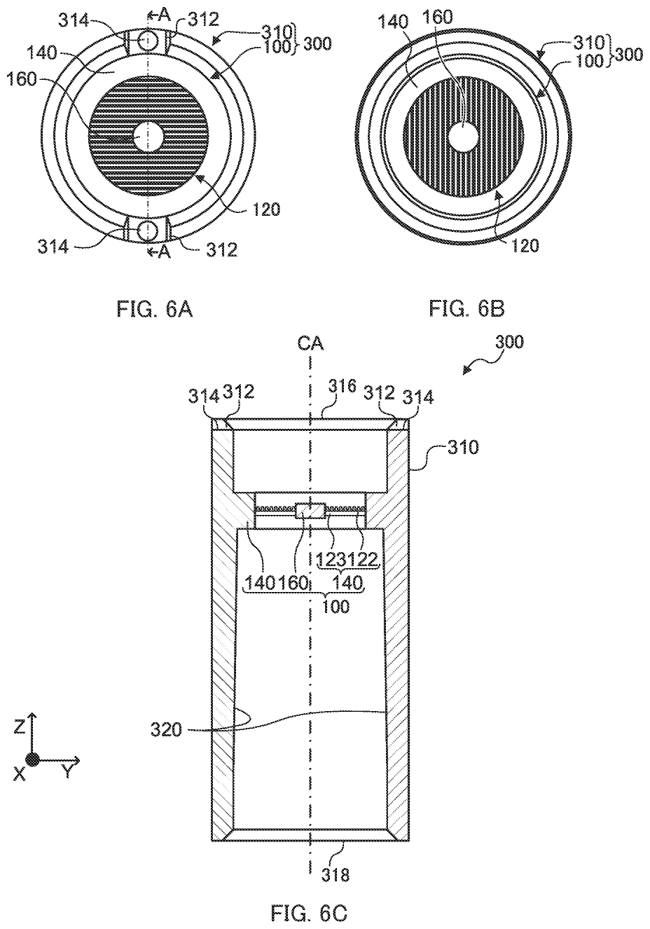

FIGS. 6A to 6C illustrate the configuration of cartridge 300 with at least one filter in embodiment 3 of the present invention. FIG. 6A is a plan view of cartridge 300 with at least one filter, FIG. 6B is a bottom view of the cartridge with at least one filter, FIG. 6C is a cross-sectional view taken along line A-A of FIG. 6A.

As illustrated in FIGS. 6A to 6C, cartridge 300 with at least one filter includes mesh filter 100 and cylinder 310. Rim portion 140 of mesh filter 100 constitutes a part of cylinder 310. Mesh filter 100 and cylinder 310 are integrally molded.

Mesh filter 100 according to the present embodiment is substantially the same as mesh filter 100 according to embodiment 1. The openings of mesh filter 100 are open in the direction along the central axis of cylinder 310. The mesh opening of mesh filter 100 is preferably 10 to 500 μm.

Cylinder 310 is disposed so as to surround mesh filter 100 and holds mesh filter 100. In the present embodiment, cylinder 310 is made of a resin such as polypropylene (PP), polyacetal (POM), or polyamide (PA), and is an integrally molded body. Cylinder 310 may have any shape as long as cylinder 310 can hold mesh filter 100. In the present embodiment, cylinder 310 has a shape of a cylinder with a substantially circular cross section. At one end of cylinder 310, pair of notched portions 312 and 312 are formed and mesh filter 100 is disposed. Pair of notched portions 312 and 312 are disposed at the one end of cylinder 310 so as to be evenly spaced in the circumferential direction of the cylinder. Gate marks 314 are formed at pair of notched portions 312 and 312, respectively. First opening 316 at the one end of cylinder 310 and second opening 318 at the other end of cylinder 310 may have any shape. The shape of first opening 316 and the shape of second opening 318 may be the same or different. In the present embodiment, first opening 316 and second opening 318 both have a circular shape. The opening edge of first opening 316 and the opening edge of second opening 318 are each formed in a tapered shape. Mesh filter 100 is connected to inner side surface 320 of cylinder 310. Mesh filter 100 may be at any position in the direction connecting first opening 316 and second opening 318 (direction along central axis CA) in cylinder 310. This position is appropriately set according to the application of cartridge 300 with at least one filter.

Effects

As described above, cartridge 300 with at least one filter according to the present embodiment includes integrally molded resin-made mesh filter 100 and cylinder 310, and thus cartridge 300 with at least one filter can be manufactured at low cost with a high yield.

### Embodiment 4

Cartridge 400 with at least one filter in embodiment 4 will be described.

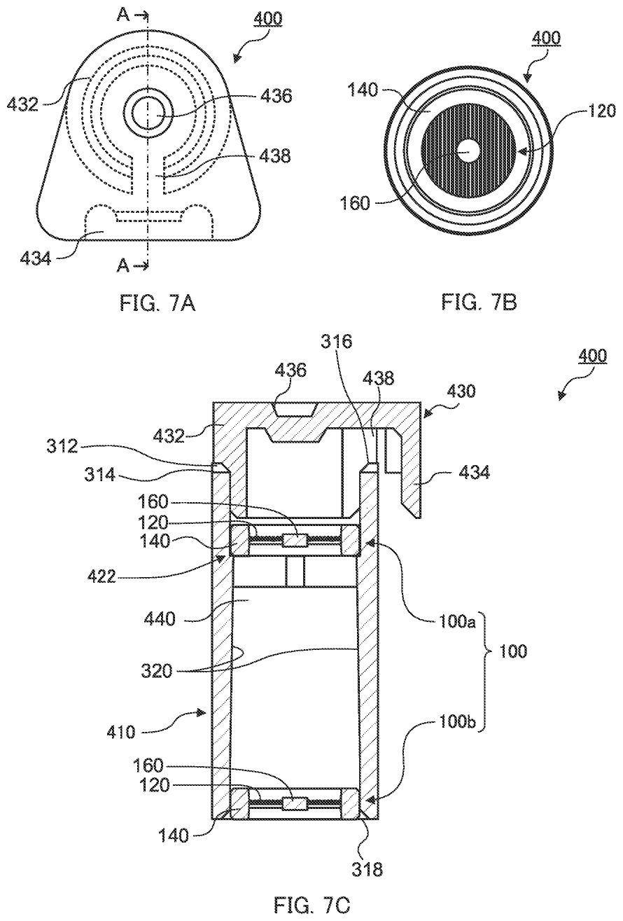

FIGS. 7A to 7C illustrate the configuration of cartridge 400 with at least one filter according to embodiment 4 of the present invention. FIG. 7A is a plan view of cartridge 400 with at least one filter, FIG. 7B is a bottom view of the cartridge with at least one filter, FIG. 7C is a cross-sectional view taken along line A-A of FIG. 7A.

As illustrated in FIGS. 7A to 7C, cartridge 400 with at least one filter includes at least one mesh filter 100, cylinder 410, and cap 430. Mesh filter 100 and cylinder 410 are integrally molded.

At least one mesh filter 100 includes first mesh filter 100a and second mesh filter 100b. First mesh filter 100a and second mesh filter 100b are substantially the same as mesh filter 100 according to Embodiment 1. First mesh filter 100a includes mesh portion 120, rim portion 140, and final filling portion 160. Second mesh filter 100b includes mesh portion 120, rim portion 140, and final filling portion 160. In each of first mesh filter 100a and second mesh filter 100b, a plurality of ribs are disposed in a grid pattern. First mesh filter 100a and second mesh filter 100b are each made of a resin and molded by integral molding.

Cylinder 410 holds mesh filter 100. Cylinder 410 may have any shape as long as cylinder 410 can hold mesh filter 100. In the present embodiment, cylinder 410 has a shape of a cylinder with a substantially circular cross section.

At one end of cylinder 410, pair of notched portions 312 and 312 are formed. Pair of notched portions 312 and 312 are disposed at the one end of the cylinder so as to be evenly spaced in the circumferential direction of the cylinder. Gate marks 314 are formed at pair of notched portions 312 and 312, respectively. First opening 316 at the one end of cylinder 410 and second opening 318 at the other end of cylinder 410 may have any shape. The shape of first opening 316 and the shape of second opening 318 may be the same or different. In the present embodiment, first opening 316 and second opening 318 both have a circular shape. The opening edge of first opening 316 and the opening edge of second opening 318 are each formed in a tapered shape. Step portion 422 is disposed on inner side surface 320 of cylinder 410.

Step portion 422 may have any shape. In the present embodiment, step portion 422 is disposed on inner side surface 320 of cylinder 410. Step portion 422 holds first mesh filter 100a from the other end side and the side surface side. Step portion 422 may be at any position in the direction connecting first opening 316 and second opening 318 in cylinder 410. This position is appropriately set according to the application of cartridge 400 with at least one filter.

Cap 430 prevents first mesh filter 100a from coming out of cylinder 410 from the one end side. Cap 430 is to be disposed at one end of cylinder 410. Cap 430 includes cap body 432 and outer side wall portion 434. Cap body 432 is formed in such a way that cap body 432 is to engage with the inner peripheral surface of cylinder 410. Recess 436 is formed in the top surface of cap body 432. In addition, communication portion 438 that communicates with the outside is formed in cap body 432. Communication portion 438 functions, for example, as a channel for a liquid, such as a sample passing through first mesh filter 100a via below-described reagent storage portion 440, from the inside of cap 430 to the outside in the radial direction. Outer side wall portion 434 changes the flow direction of the liquid, which has passed through communication portion 438, toward the lower side in FIG. 7C along the outer wall of cylinder 410.

In the present embodiment, first mesh filter 100a is placed into cylinder 410 from one end of cylinder 410 so as to come into contact with step portion 422. Cap 430 is then placed by inserting cap 430 from the one end side of cylinder 410. By press fitting second mesh filter 100b into the other end of cylinder 410, second mesh filter 100b is placed into cylinder 410.

The space between first mesh filter 100a and second mesh filter 100b can function as, for example, reagent storage portion 440. In such a case, cartridge 400 with at least one filter according to the present embodiment can also be used for a predetermined reaction using a biological sample or the like. For example, a biological sample is injected from the one end side or the other end side of cylinder 410 with a solid reagent previously placed in reagent storage portion 440. When the biological sample is injected from the other end side, the biological sample passes through second mesh filter 100b and flows into reagent storage portion 440. The biological sample flowing into reagent storage portion 440 reacts with the reagent previously stored in reagent storage portion 440. First mesh filter 100a retains a solid reagent, a solid carrier for capturing an object, and the like in reagent storage portion 440.

The openings of first mesh filter 100a and second mesh filter 100b are open in the direction along the central axis of cylinder 410.

Effects

Cartridge 400 with at least one filter according to the present embodiment provides substantially the same effects as that of cartridge 300 with at least one filter in embodiment 3.

This application claims priority based on Japanese Patent Application No. 2018-226275, filed on Dec. 3, 2018, the entire contents of which including the specification and the drawings are incorporated herein by reference.

### INDUSTRIAL APPLICABILITY

The mesh filters according to the present invention are advantageous for removing foreign substances from fluids such as liquids and gases. The mesh filters according to the present invention include a finer mesh than conventional mesh filters, and thus particularly advantageous for removing foreign substances in biological samples.

### REFERENCE SIGNS LIST

100, 200 Mesh filter
120, 220 Mesh portion
121 Hole
122, 222 First rib
123, 223 Second rib
124 First ridge line
125 Second ridge line
140 Rim portion
141, 314 Gate mark
142 Gate portion
143 Cavity
144 Space corresponding to rim portion
145 Space corresponding to first rib
146 Space corresponding to second rib
160 Final filling portion
300, 400 Cartridge with at least one filter
310, 410 Cylinder
312 Notched portion
316 First opening
318 Second opening
320 Inner side surface
422 Step portion
430 Cap
432 Cap body
434 Outer side wall portion
436 Recess
438 Communication portion
440 Reagent storage portion
P Virtual plane

What is claim is:

1. A mesh filter that is an integrally molded resin product, the mesh filter comprising:
a mesh portion in which a plurality of ribs are disposed in a grid pattern;
a rim portion formed in an annular shape so as to surround the mesh portion, the rim portion being a portion to which the plurality of ribs are connected; and
a final filling portion disposed inside the rim portion, the final filling portion being a portion to which a part of ribs among the plurality of ribs are connected, wherein
a cross-sectional area of at least one rib of the part connected to the final filling portion is smaller than a cross-sectional area of at least one rib of another part, which is not connected to the final filling portion, in the plurality of ribs.

2. The mesh filter according to claim 1, wherein:
the mesh portion has a circular shape in plan view; and
the final filling portion has a circular shape in plan view.

3. The mesh filter according to claim 2, wherein the final filling portion is disposed at a central part inside the rim portion.

4. The mesh filter according to claim 1, wherein:
the plurality of ribs include
a plurality of first ribs extending in a first direction and disposed parallel to each other, and
a plurality of second ribs extending in a second direction and disposed parallel to each other, the second direction being perpendicular to the first direction.

5. The mesh filter according to claim 4, wherein the plurality of first ribs and the plurality of second ribs are disposed at different positions from each other in a height direction of the plurality of ribs.

6. The mesh filter according to claim 4, wherein the plurality of first ribs and the plurality of second ribs are disposed at an identical position in a height direction of the plurality of ribs.

7. The mesh filter according to claim 2, wherein:
the plurality of ribs include
a plurality of first ribs extending in a first direction and disposed parallel to each other, and
a plurality of second ribs extending in a second direction and disposed parallel to each other, the second direction being perpendicular to the first direction.

8. The mesh filter according to claim 3, wherein:
the plurality of ribs include
a plurality of first ribs extending in a first direction and disposed parallel to each other, and
a plurality of second ribs extending in a second direction and disposed parallel to each other, the second direction being perpendicular to the first direction.

9. The mesh filter according to claim 7, wherein the plurality of first ribs and the plurality of second ribs are disposed at different positions from each other in a height direction of the plurality of ribs.

10. The mesh filter according to claim 8, wherein the plurality of first ribs and the plurality of second ribs are disposed at different positions from each other in a height direction of the plurality of ribs.

11. The mesh filter according to claim 7, wherein the plurality of first ribs and the plurality of second ribs are disposed at an identical position in a height direction of the plurality of ribs.

12. The mesh filter according to claim 8, wherein the plurality of first ribs and the plurality of second ribs are disposed at an identical position in a height direction of the plurality of ribs.
